(19) United States
(12) Patent Application Publication
(10) Pub. No.: US 2014/0143270 A1
(43) Pub. Date: May 22, 2014

(54) GENERATING DYNAMIC DRILLDOWN REPORTS

(71) Applicants: James Michael AMULU, Bangalore (IN); Suhail David LALL, Bangalore (IN)

(72) Inventors: James Michael AMULU, Bangalore (IN); Suhail David LALL, Bangalore (IN)

(21) Appl. No.: 13/680,171

(22) Filed: Nov. 19, 2012

(51) Int. Cl. G06F 17/30

(52) U.S. Cl. 707/769; 707/E17.014

(57) ABSTRACT

Various embodiments of systems and methods for generating dynamic drilldown reports are described herein. A drilldown request may be received for a data value included in the drilldown report. An attribute of the data value, for which the drilldown request has been received, may then be identified. Associated attributes corresponding to the identified attribute may then be determined from an in-memory database attribute relationship table stored in the in-memory database. Next, database tables may be searched, based on the data value included in the drilldown report, to retrieve data values corresponding to the associated attributes. A child drilled report may be generated based on the data values retrieved from the database tables.

### FIELD

Embodiments generally relate to computer systems, and more particularly to methods and systems for generating dynamic drilldown reports.

### BACKGROUND

Drilldown reports are commonly used in the industry for allowing different users to drilldown into reports according to the information required by the user. At present, the different drilldown reports are pre-built and connected to each other. A user may jump between these pre-build reports based on the connection defined between the reports. These drilldown reports include static data values that are collected at the time of building these reports. Therefore, these drilldown reports do not show the current data values, which is undesirable.

### BRIEF DESCRIPTION OF THE DRAWINGS

The claims set forth the embodiments with particularity. The embodiments are illustrated by way of example and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating a method for generating a child drilled report corresponding to a parent drilldown report, according to an embodiment.

FIGS. 2A-C is a detailed flow diagram illustrating a method for generating a child drilled report corresponding to a parent drilldown report, according to an embodiment.

FIG. 3 is an exemplary block diagram illustrating a source in-memory database model, according to an embodiment.

FIG. 4 is an exemplary in memory database attribute relationship table that stores the drilldown information of the source in memory database model shown in FIG. 3, according to an embodiment.

FIG. 5 is a block diagram illustrating an exemplary drilldown report, according to an embodiment.

FIG. 6 is a block diagram illustrating a computing environment in which the techniques described for dynamically generating drilldown reports can be implemented, according to an embodiment.

### DETAILED DESCRIPTION

Embodiments of techniques for generating dynamic drilldown reports are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

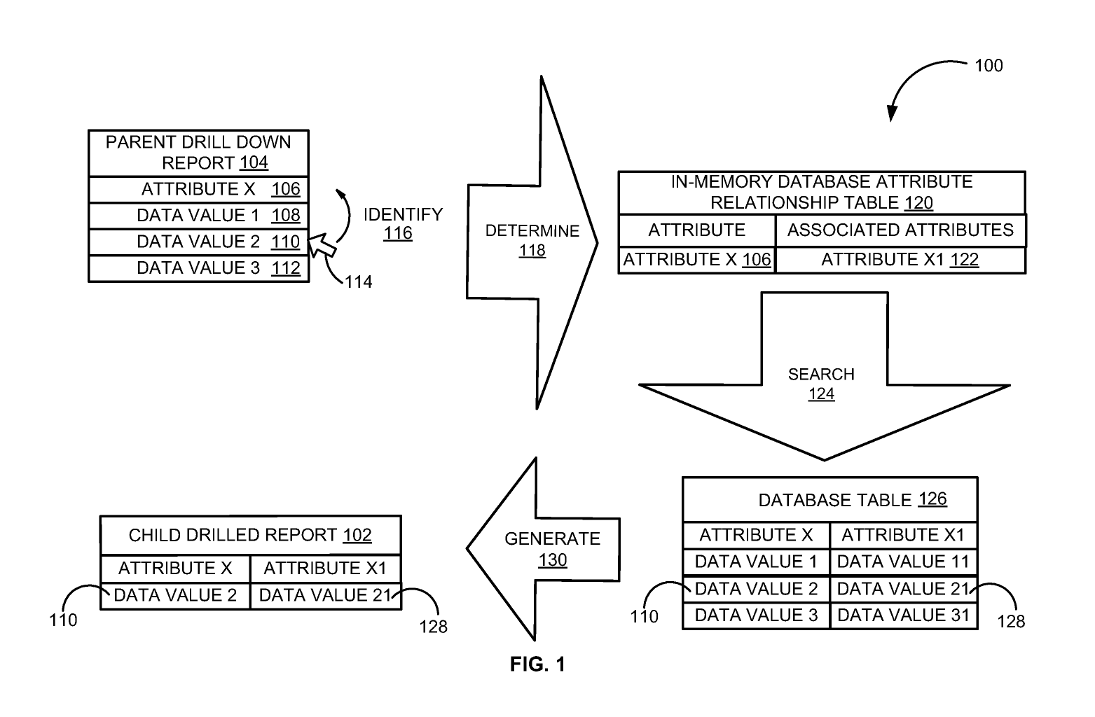

FIG. 1 is a block diagram illustrating a method 100 for generating a child drilled report 102 corresponding to a parent drilldown report 104, according to an embodiment. Drilldown operation may be an operation to obtain additional information related to an entity. A drilldown operation in a report may allow a user to obtain additional information related to the entities in the report. The additional information may include next level of details for the entities in the report, or the next report object on the same level. The additional information related to entities in a parent drilldown report 104 may be presented in a child drilled report 102. For example, an employee drilldown report including employee names may allow a user to perform a drilldown operation on a selected employee name to obtain additional information related to the selected employee. The additional information related to the employee, for example, an employee identification number may be displayed on a child drilled report, corresponding to the employee drill down report, for employees along with the employee name.

A report refers to information automatically retrieved from a data source (e.g., a database, a data warehouse, and the like). In one embodiment, the report may include attributes and measures. Attributes may refer to descriptive data like customer ID, city, country, etc. Measures may refer to quantifiable data such as revenue, quantity sold, counters, etc. The report may also include data values corresponding to the attributes and measures included in the report. For example, the parent drilldown report 104 may include an attribute X 106 having three data values, data value 1 108, data value 2 110, and data value 3 112. Next, a request may be received for obtaining additional information related to any of the data values, data value 1 108, data value 2 110, and data value 3 112, in the parent drilldown report 104. For example, in the parent drilldown report 104 a drilldown request 114 may be received for obtaining additional information related to the data value 2 110 in the parent drilldown report 104.

An attribute of the data value, for which the drilldown request has been received, may next be identified 116. In the parent drilldown report 104, the attribute of the data value 2 110, for which the drilldown request 114 has been received, may be identified at 116 as attribute X 106. Next, associated attributes corresponding to the identified attribute may be determined at 118 from an in an in-memory database attribute relationship table 120. The in-memory database attribute relationship table 120 may include the relationship between the attributes included in database tables, stored in the in-memory database. The database tables may also include the data values corresponding to the attributes included in the database tables. In one embodiment, the data value of an associated attribute, corresponding to an attribute, may include the additional information related to the data value of the attribute. In the above example, an attribute X1 122 may be identified as associated attribute for the selected attribute 106 from the in memory database attribute relationship table 120. Next database tables may be searched 124, to retrieve data value of the associated attribute, corresponding to the data value, for which the drilldown request is received. The retrieved data value may be the additional information related to the data value, for which the drilldown request is received.

For example, consider that a drilldown request is received for a data value “CALIFORNIA”, in a US population drilldown report, corresponding to an attribute “US STATE”. An associated attribute corresponding to the attribute “US STATE” may be determined as “STATE POPULATION” from an in-memory database attribute relationship table. The database table may then be searched to retrieve the data value “38,000,000” of the associated attribute “STATE POPULATION”, in the database tables, corresponding to the data value “CALIFORNIA. The data value “38,000,000” may be the additional information corresponding to the data value “CALIFORNIA”. In the above example, a search at 124 may be performed on the database table 126 to retrieve the data value 21 at 128 of the associated attribute X1 at 124 corresponding to the data value 2 at 110, for which the drilldown request is received. The data value 21 at 128 may be the additional information related to the data value 2 at 110.

Finally, the data values, retrieved from the database tables, may be used to generate at 130 the child drilled report 102. The generated child drilled report 102 may include the data values, retrieved from the data base tables, and the data value, for which the drilldown request has been received. In the above example, the child drilled report 102 may include the data value 21 at 128, retrieved from the database table 126, and the data value 2 at 110, for which the drilldown request has been received. As the drilldown operation is being performed based on relationship between the attributes, in the database tables, the child drilled down report may be dynamically generated based on the latest data values in database tables. In the above example for US population drilldown report, consider that the population for “CALIFORNIA” is changed from “38,000,000” to “40,000,000” in the database table. In this case, the next time a user clicks on “CALIFORNIA” for a drilldown operation then the latest population data “40,000,000, for the associated attribute “STATE POPULATION”, may be retrieved from the database table. In this case, the dynamically generated child report may include “CALIFORNIA” and the latest population data “40,000,000”.

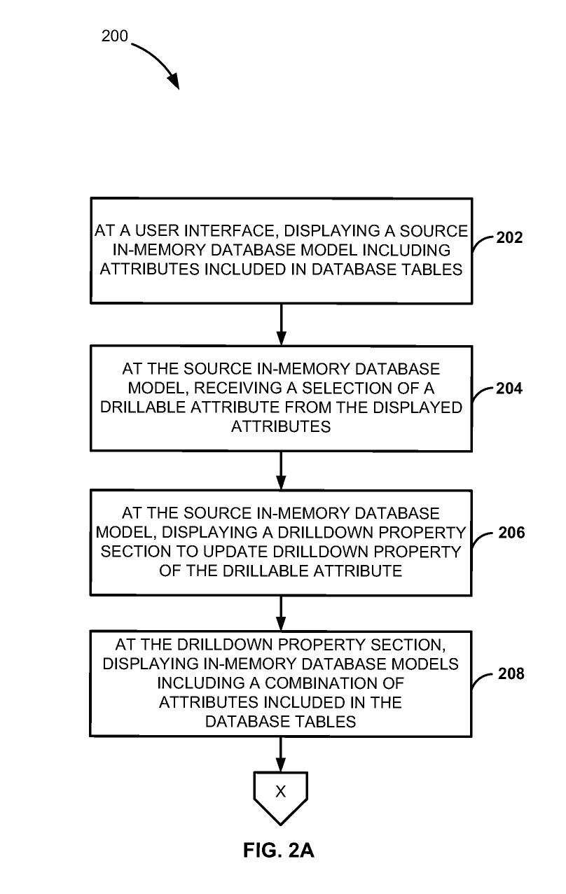

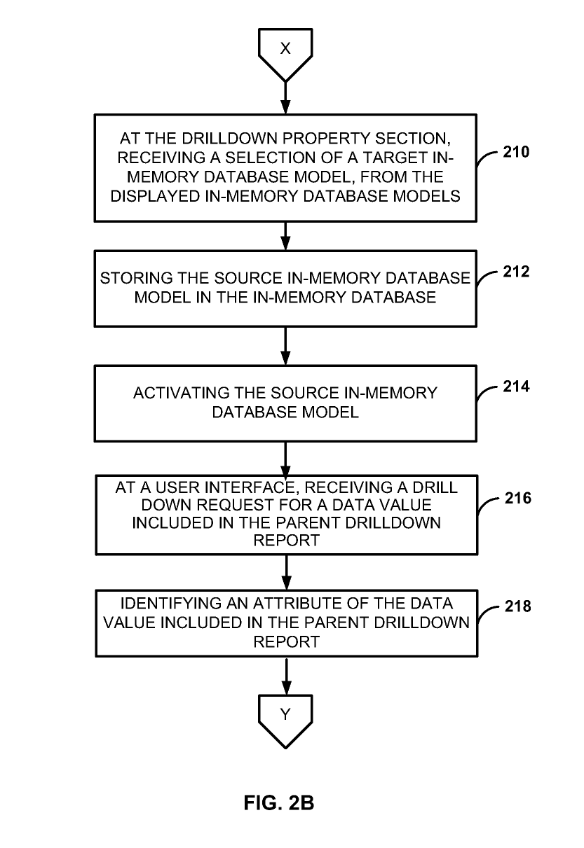

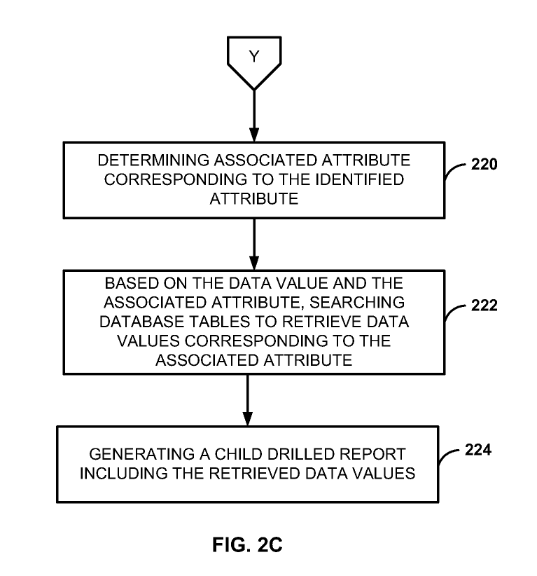

FIGS. 2A-C is a detailed flow diagram 200 illustrating a method for generating a child drilled report corresponding to a parent drilldown report, according to an embodiment. In one embodiment, blocks 202-214 may be executed at design time to define drilldown relationships between the attributes and measures included in database tables, stored in the in-memory database. Next blocks 216-224 may be executed to generate a child drilled report corresponding to a parent drilldown report, based on the defined drilldown relationships between the attributes and measures. In one embodiment, in-memory database models may be used to define the drilldown relationships between attributes and measures included in database tables. The database tables may be stored in in-memory database. The drilldown relationship may define a relationship between an attribute, included in a parent drilldown report, and the corresponding associated attributes, the data value of which are to be included in a child drilldown report.

An in-memory database model may include attributes and measures included in the database tables stored in the in-memory database. The in-memory database model may allow a user to model the attributes and measures included in the database tables stored in the in-memory database. Data modeling is the analysis of data objects that are used in a business or any other context, and the identification of the relationships among these data objects. The in-memory database model may allow a user to perform different modeling operations, for example, the in-memory database model may allow a user to define relationship between the different attributes and measures included in the in-memory database mode, or to define additional properties for a particular attribute, etc. Data, from the data tables, may be retrieved and processed at run time, based on the attribute relations and attribute definitions defined in the in-memory database model. In one embodiment, the attributes and measures included in the in-memory database tables may correspond to a particular context. For example, an in-memory database model for a finance context may be used for modeling attributes and measures included in finance related database tables, an income table, an expense table, and a saving table, stored in the in-memory database. The in-memory database model may include the attributes and measures included in the income, expense, and saving tables. The attributes and measures in the finance in-memory database model may allow a user to define relationships between the attributes and measures included in the finance related database tables or to modify the properties of any of the attributes and measures. For example, the finance in-memory database model may be used to define that property of an “amount remaining” attribute in the expense table as hidden. In this case, the attribute “amount remaining” may be hidden from an end user at run time.

Initially at block 202, a source in-memory database model including attributes, included in database tables, may be displayed at a user interface. As discussed above, the source in-memory database model includes the attributes and measures included in the database tables, stored in the in-memory database. The attributes and measures included in the source in-memory database model may be displayed at the user interface. In one embodiment, the attributes and measures of database tables, corresponding to a particular context, may be included in the source in-memory database model. In this case, the in-memory database model includes attributes and measures, corresponding to a particular context. A user may perform a modeling operation on the displayed attributes and measures using the in-memory database model. For example, assume that the in-memory database stores two database tables, “customer sales” table and a “customer location” table, corresponding to a “customer” context. The “customer sales” table and the “customer location” table, may include four attributes “customer name”, “customer identification”, “customer sales”, and “customer country”. A customer in-memory database model may include the four attributes “customer name”, “customer identification”, “customer sales”, and “customer country”, corresponding to the “customer” context. The customer in-memory database model including the four attributes “customer name”, “customer identification”, “customer sales”, and “customer country” may be displayed to a user. In one embodiment, the user may select the attributes and measures, from the displayed list of attributes and measures, on which the user wants to perform the modeling operation. In the above example, the user may select three attributes, “customer name”, “customer sales”, and “customer country”, from the displayed four attributes, on which the user wants to perform the modeling operation. In one embodiment, the attributes and measures included in the source in-memory database model may be included in a parent drilldown report. The parent drilldown report may also include data values corresponding to the attributes and measures included in the source in-memory database model.

Next at block 204, the source in-memory database model may receive a selection of a drillable attribute from the attributes and measures displayed at block 202. The selected drillable attribute may be an attribute for which the user wants to provide the drilldown operation. The drilldown operation may be performed on any of the data values corresponding to the drillable attribute. A measure included in the displayed in-memory database model may also be selected as a drillable attribute. The user may select the drillable attribute from the attributes and measures selected, by the user, for performing the drilldown modeling operation at block 202. In one embodiment, the user may select any number of attributes or measures as drillable attributes. In the above example, the user may select the “customer sales” attribute as a drillable attribute from the attributes, “customer name”, “customer sales”, and “customer country”, selected for performing the modeling operation.

Next, at block 206 a drilldown property section, corresponding to the drillable attribute selected at block 204, may be displayed at the in-memory database model. The drilldown property section may be displayed to update the drilldown property of the selected drillable attribute. The drilldown properties may be used to define the drilldown relationship between the drillable attribute and associated attributes corresponding to the drillable attribute. Associated attributes may be any of the attributes or measures included in the database tables stored in the in-memory database. The data corresponding to the associated attribute may include the additional information for the data values corresponding to the drillable attribute.

In one embodiment, a list of in memory database models may be displayed at the drilldown property section for selecting associated attributes corresponding to the drillable attribute (block 208). In one embodiment, each of the in-memory database models may include a different combination of attributes and/or measures included in the database tables stored in the in-memory database. In the above example, two activated in-memory database models, “customer sales details” model and “customer address details” model, may be displayed at the drilldown property section. The “customer sales details” model may include a “customer sales for product A”, “customer sales for product B”, and “customer sales location” attributes. The “customer address details” model may include a “customer office address” attribute and “customer home address” attribute. The in-memory database model displayed at the drilldown property section may be activated in-memory database models. In one embodiment, an activated in-memory database model is a database view, such as an SQL view. A database view may include a database query and may return a virtual table obtained based on executing the database query on the database tables, stored in the in-memory database. The activated in-memory database table may return a virtual table that includes the combination of the attributes and measures included in the activated in-memory database model.

Next at block 210, a selection may be received for a target in-memory database model from the in-memory database models displayed at block 208. The combination of attributes and/or measures in the selected target in-memory database model may be the associated attributes corresponding to the drillable attribute. In the above example, the user may select the “customer sales details” model as the target in-memory database model. In this case, the “customer sales for product A” attribute, “customer sales for product B” attribute, and “customer sales location” attribute, included in the “customer sales details” model may be identified as the associated attribute corresponding to the drillable attribute. In one embodiment, the combination of the attributes and/or measures in the selected target in-memory database model may be displayed to a user. The user may then select any of the attributes and/or measures, from the displayed combination of attributes and/or measures, as associated attributes corresponding to the drillable attribute. In the above example, the attributes “customer sales for product A” attribute, “customer sales for product B” attribute, and “customer sales location” attribute may be displayed to a user. The user may then select “customer sales for product A” attribute, “customer sales for product B”, from the displayed attributes, as the associated attribute corresponding to the “customer sales” attribute.

In one embodiment, the type of drilldown operation, synchronous operation or asynchronous operation, for the drillable attribute may be defined based on the selection of the attributes in the target in-memory database module. A synchronous drilldown operation may provide the next level of details for the data value of the drillable attribute. In the above example, a synchronous drilldown operation may be defined for the drillable attribute “customer sales” when the user selects “customer sales for product A” and “customer sales for product B” as the associated attributes for the drillable attribute “customer sales”. The data values for the associated attributes “customer sales for product A” and “customer sales for product B” may provide the next level of detail for data values corresponding to the drillable attribute “customer sales”. An asynchronous drilldown operation may provide additional details, at the same level, for the data value of the drillable attribute along with the next level of details for the data value of the drillable attribute. In the above example, an asynchronous drilldown operation may be defined for the drillable attribute “customer sales” when all the attributes “customer sales for product A”, “customer sales for product B”, and “customer sales location”, in the “customer sales details” model, are selected as associated attributes for the drillable attribute “customer sales”. The data values for the associate attribute “customer sales location” may provide additional details at the same level for the data values corresponding to the drillable attribute “customer sales”, and the data values for the associated attributes “customer sales for product A” and “customer sales for product B” may provide the next level of detail for data values corresponding to the drillable attribute “customer sales.”

Next at block 212, the source in-memory database model may be stored in the in-memory database. The source in-memory database model may include the relationship between the drillable attribute, selected at block 204, and the target in-memory database model, selected at block 210, including the associated attributes corresponding to the drillable attribute. In the above example, the “customer” in memory database model may include the relationship between the selected attribute “customer sales” and the target “customer sales details” attribute. Next at block 214, the source in-memory database model stored in the in-memory database may be activated. In one embodiment, activation is the process of converting the source drilldown report to an activated in-memory database model, which may be queried by a client. The activated in-memory database model may allow a client, for example an SQL client, to query the database tables, based on the relationships between the drillable attribute and the target in-memory database model, stored in the source in-memory database model.

In one embodiment, the activated in-memory database model may be stored in an in-memory database attribute relationship table. The in-memory database attribute relationship table may also store the target in-memory database model, selected at block 212, and the drillable attribute, selected at block 204. The in-memory database attribute relationship table may also store the associated attributes, corresponding to the drillable attribute, included in the target in-memory database model.

In one embodiment, blocks 204-214 may be repeated for another attribute in the source in-memory database model to identify and store the associated attributes corresponding to the another attribute, in the attribute relationship table. For example, a user may select the “customer country” attribute, as the drillable attribute, from the customer source in-memory database model. In this case, the “customer location details” model may be selected as the target in-memory database model. The attributes, “customer office address” attribute and “customer home address” attribute, in the “customer location details” model may be selected and stored as the associated attribute corresponding to the “customer country” attribute.

In one embodiment, a multi-level drilldown reporting may be provided by repeating the steps in blocks 202-214 for the target in-memory database model selected at block 210. Specifically, a drillable attribute may be selected from the attributes in the target in-memory database model selected at block 210. Associated attributes corresponding to selected attribute, of the target model, may be selected by selecting a target in-memory database model for the drillable attribute. The drillable attribute, of the target in-memory database model, and the associated attribute may be stored in the in-memory database attribute relationship table. Based on this, any level of drilldown operations may be provided by defining relationship between attributes included in the in-memory database models. In the above example, the steps in blocks 202-214 may be repeated for the “customer location details” target in memory database model. In this case, a “customer sales for product A” attribute, in the “customer location details” model, may be selected as the drillable attribute. Next, a “quarterly sales of product A” model may be selected as the target in-memory database model for the “customer sales for product A” attribute. The attributes, “sales of product A in Q1”, “sales of product A in Q2”, “sales of product A in Q3”, and “sales of product A in Q4”, in the “quarterly sales of product A” model may be selected as associated measure for the drillable “customer sales for product A” attribute. A user may then perform two levels of drilldown, based on the associated attributes selected for a drillable attribute in the target in-memory database model. A user may perform a first level of drilldown on a data value of the “customer sales” attribute to obtain the values of associated attributes “customer sales for product A” and “customer sales for product B”. A second level of drilldown may then be performed on a data value of the “customer sales for product A” attribute to obtain the data values of the associated attributes “sales of product A in Q1”, “sales of product A in Q2”, “sales of product A in Q3”, and “sales of product A in Q4.”

Next blocks 216-224 may be executed, at run time, to generate the child drilled report corresponding to the parent drilldown report based on the drilldown relationship between the drillable attribute and the associated attribute corresponding to the drillable attribute. At block 216, a request may be received for drilling down on a data value included in the parent drilldown report. In one embodiment, the parent drilldown report may include the attributes and measures included in the source in-memory database model. The parent drilldown report may also include data values corresponding to the attributes and measures in the drilldown report. The drillable attributes and measures in the parent drilldown report may be highlighted to indicate that drilldown is enabled for the data values corresponding to the drillable attributes and measures. The drilldown request may be received for obtaining additional information related to the selected attribute. In the above example, a parent drilldown report may include the attributes “customer name”, “customer identification”, “customer country”, and “customer sales” included in the source in memory database model. The drillable attribute “customer country” and the drillable measure “customer sales” may be highlighted. A drilldown request may be received for a data value “US” in the parent drilldown report.

Next at block 218, an attribute or measure of the selected data value may be determined. In the above example, the attribute of the selected data value “US” may be identified as “customer country”. Next at block 220 an associated attribute corresponding to the identified attribute may be identified. The associated attribute corresponding to the identified attribute may be identified based on the drilldown relationship between the identified (drillable) attribute and the target in-memory database model stored in the source in-memory database model. The source in-memory database model storing the drilldown relationship may be obtained from the in-memory database attribute relationship table. The attributes and measures included in the target in-memory database model may be determined as the associated attribute corresponding to the identified attribute. In the above example, based on the drilldown relationship stored in the “customer” source in memory model, the “customer address details” model may be identified as the target in-memory database model for the identified “customer country” attribute. The attributes “customer office address” and “customer home address”, included in the “customer address details” model may be determined as associated attributes corresponding to the identified “customer country” attribute.

Next at block 222, the database tables, stored in the in-memory database, may be searched based on the associated attributes, determined at block 220, and the data value for which the drilldown request has been received at block 216. In one embodiment, the database tables may be searched to retrieve the data value of the associated attribute corresponding to the data value, for which the drilldown request has been received. In the above example, the database tables may be searched to retrieve the data values of the “customer office address” and the “customer home address” attributes corresponding to the data value “US”. In this case, assume that the data value, stored in the in-memory database, for “customer office address” and the “customer home address” attribute is “ABC STREET, PALO ALTO, US” and “XYZ STREET, PALO ALTO, US.” These data values, “ABC STREET, PALO ALTO, US” and “XYZ STREET, PALO ALTO, US”, of the associated attributes may be retrieved from the database tables.

Finally at block 224, the value retrieved from the database tables, at block 222, may be used to generate the child drilled report. The generated child drilled down report may include the retrieved data values of the associated attributes and the data value for which the drilldown request has been received. In the above example, the child drilldown report may include the retrieved data values “ABC STREET, PALO ALTO, US” and “XYZ STREET, PALO ALTO, US” and the data value “US” for which the drilldown request has been received.

As discussed above, multiple levels of drilldown may be provided by defining the drilldown relationships between the attributes included in the database tables. Each of these drilldown reports may be shown in a tabbed view on a single screen. A user can easily jump between these reports by selecting the desired report from the tabbed view. For example, consider that a user drilldowns from a first report to obtain a second report. Next the user drillsdown the second report to obtain a third report. In this case, the reports which are not being displayed may be shown as a tab on the screen. For example, if the user is viewing the first report then the user may be shown two tabs corresponding to the second report and the third report. A user can jump to any of the reports by selecting the corresponding tab. For example, a user can jump directly to the third report from the first report. This may allow the user to easily jump to any of the drilled reports, depending on the level of data granularity desired by the user.

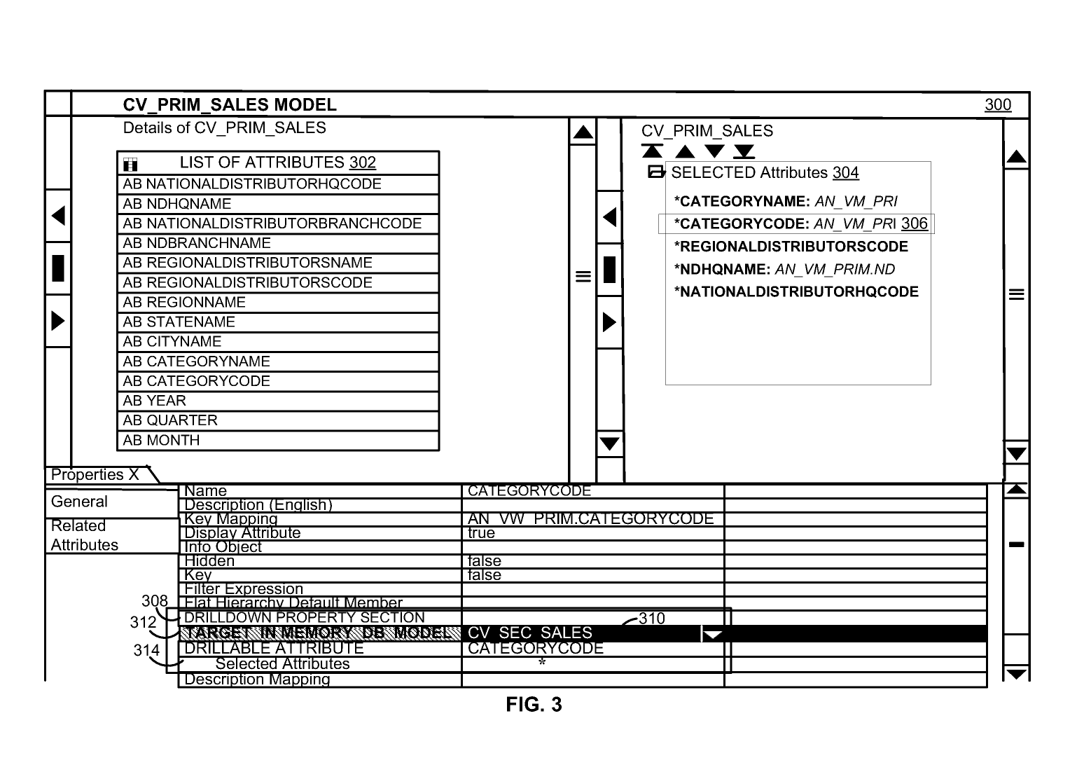

FIG. 3 is an exemplary block diagram illustrating a source in-memory database model “CV_PRIM_SALES” 300 according to an embodiment. The “CV_PRIM_SALES” model 300 may include a list of attributes 302 included in database tables, stored in the in-memory database, corresponding to “sales” context. A user may select the attributes, from the list of attributes 302, on which the user wants to perform the modeling operation. The selected attributes 304, from the list of attributes 302, may be displayed in the “CV_PRIM_SALES” model 300. Next, a user may select the “CATEGORY CODE” attribute 306, from the selected attributes 304, as a drillable attribute. A drilldown property section 308 corresponding to the selected drillable “CATEGORY CODE” attribute 306 may then be displayed at the “CV_PRIM_SALES” mode 300. The drilldown property section 308, may be used by the user, for updating the drillable properties of the drillable “CATEGORY CODE” attribute 306. In the drilldown property section 308, a user may select “CV_SEC_SALES” model 310 as a target in memory database model (TARGET_IN MEMORY_DB_MODEL 312) corresponding to the “CATEGORY CODE” drillable attribute 306. The “CV_SEC_SALES” model 310 may include a combination of attributes and measures, which may be selected as associated attributes corresponding to the “CATEGORYCODE” drillable attribute 306. In one embodiment, the user may also select some of the attributes and measures, from the attributes and measures included in the “CV_SEC_SALES” model 310, which the user wants to be defined as associated attributes corresponding to the “CATEGORYCODE” drillable attribute 306. The selected attributes, from the attributes included in the “CV_SEC_SALES” model 310, may be displayed as selected attributes 314 in the drilldown property section 308. The user may select a “*”, as the selected attribute 314, in case the user wants all the attributes and measures in the “CV_SEC_SALES” model 310 to be defined as associated attributes corresponding to the “CATEGORYCODE” drillable attribute 306. In one embodiment, the source in memory database model “CV_PRIM_SALES” 300 may store the relationship between the drillable attribute “CATEGORYCODE” 306 and the target in memory database model “CV_SEC_SALES” model 310 storing the associated attributes corresponding to the drillable attribute “CATEGORYCODE” 306.

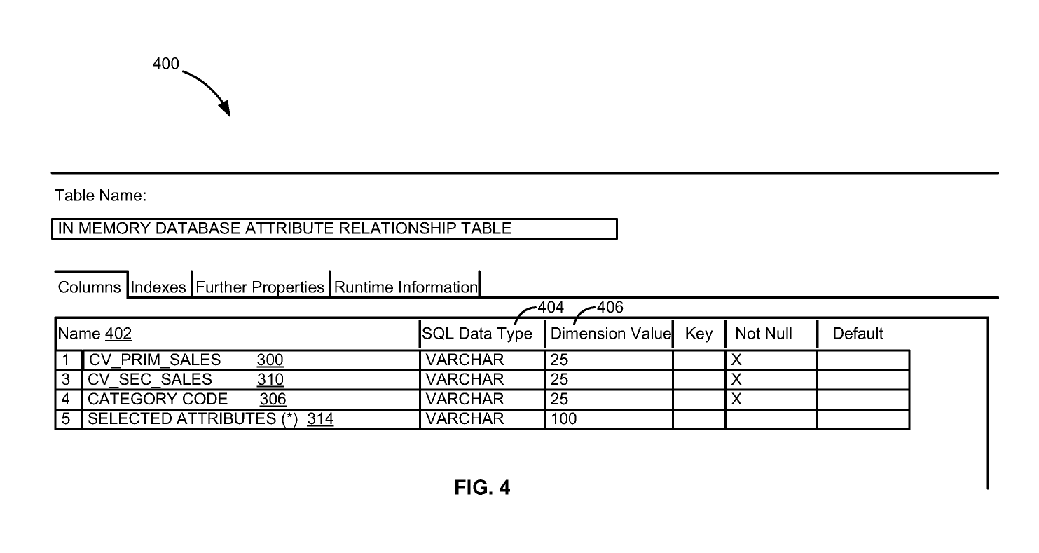

FIG. 4 is an exemplary in memory database attribute relationship table 400 that stores the drilldown information of the source in memory database model “CV_PRIM_SALES” 300 shown in FIG. 3, according to an embodiment. In one embodiment, the in memory database attribute relationship table 400 may include several entries for storing the drilldown information of the drillable attribute “CATEGORYCODE” 306 selected in the source in memory database model “CV_PRIM_SALES” 300 of FIG. 3. As shown, the table 400 stores the name 402 of the source in memory database model (CV_PRIM_SALES 300), target in memory database model (“CV_SEC_SALES” model 310), drillable attribute (CATEGORYCODE 306) and the selected attributes (*) 314, of the “CV_SEC_SALES” model 310, selected as associated attributes for the drillable attribute “CATEGORYCODE” 306. The in memory database attribute relationship table 400 may also include the data type 404 and the dimension value 406 of the source in memory database model (CV_PRIM_SALES 300), target in memory database model (“CV_SEC_SALES” model 310), drillable attribute (CATEGORYCODE 306) and the selected attributes (*) 314, of the “CV_SEC_SALES” model 310, selected as associated attributes for the drillable attribute “CATEGORYCODE” 306.

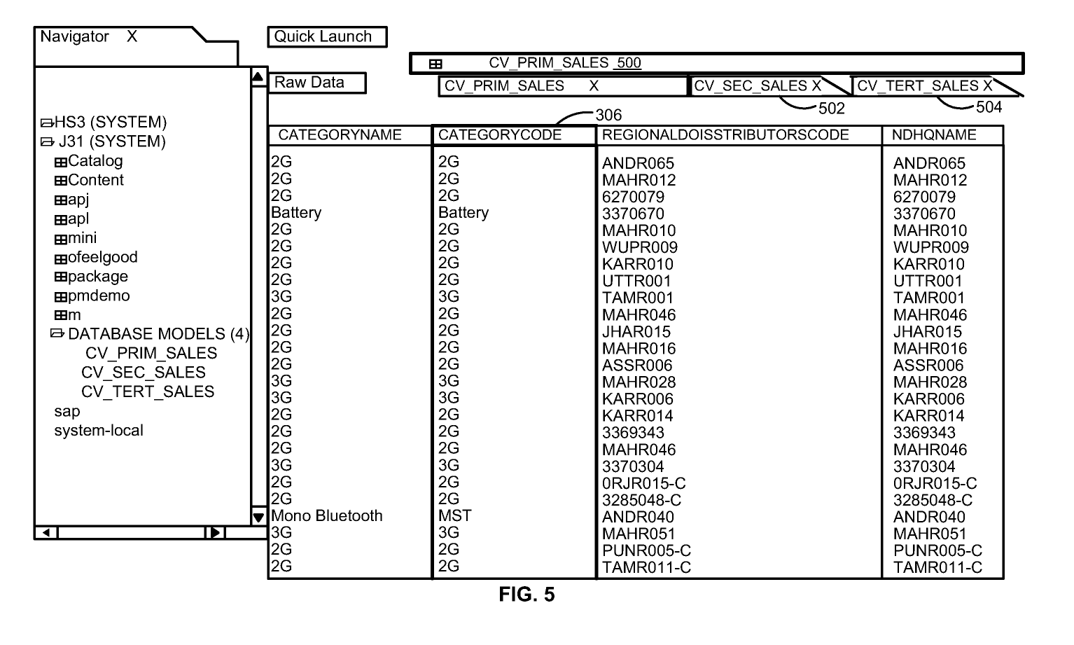

FIG. 5 is a block diagram illustrating an exemplary drilldown report “CV_PRIM_SALES” 500, according to an embodiment. The drilldown report 500 may include the attributes and measures, selected for data modeling in the source in memory database model “CV_PRIM_SALES” 300 of FIG. 3. The drillable attribute “CATEGORY CODE” 306 and the corresponding values may be highlighted in the “CV_PRIM_SALES” report 500. A drilled report “CV_SEC_SALES” may be generated when the user selects any of the values corresponding to the “CATEGORYCODE” 306 attribute. The drilled report “CV_SEC_SALES” may be generated based on the drilldown relationship, of the drillable attribute “CATEGORYCODE” 306, stored in the in memory database attribute relationship table 400 of FIG. 4. The drilled report “CV_SEC_SALES” may again be drilled to obtain a “CV_TERT_SALES” report. As shown, tabs 502 and 504 corresponding to the “CV_SEC_SALES” report and the “CV_TERT_SALES” report may be shown on top of the “CV_PRIM_SALES” report 500. A user may click on any of these tabs 502 and 504 to jump to the desired drilled report.

Some embodiments may include the above-described methods being written as one or more software components. These components, and the functionality associated with each, may be used by a client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls or web services being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

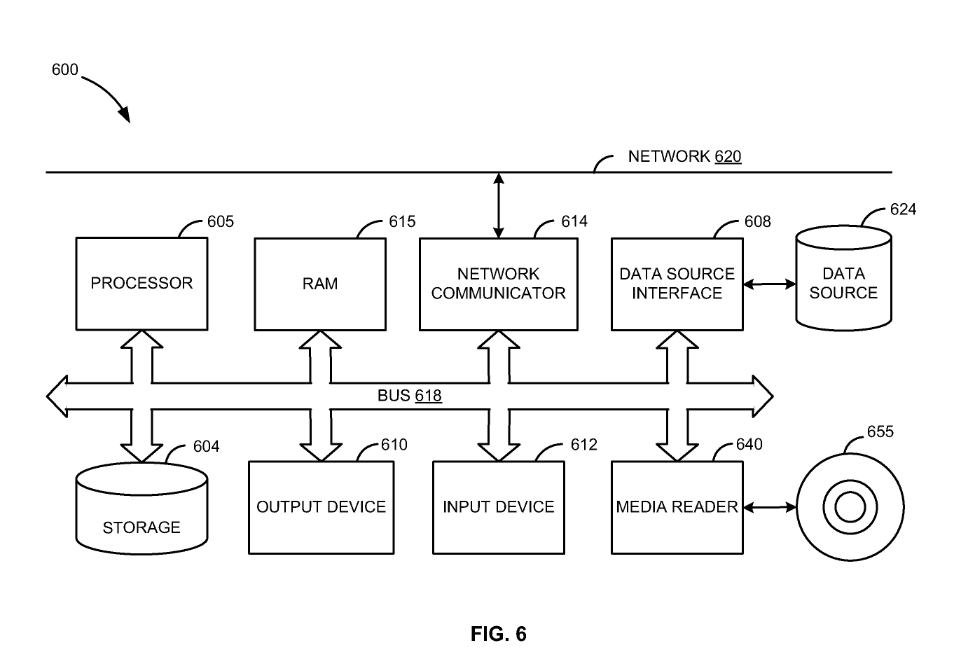

FIG. 6 is a block diagram of an exemplary computer system 600. The computer system 600 includes a processor 605 that executes software instructions or code stored on a computer readable storage medium 655 to perform the above-illustrated methods. The processor 605 can include a plurality of cores. The computer system 600 includes a media reader 640 to read the instructions from the computer readable storage medium 655 and store the instructions in storage 604 or in random access memory (RAM) 615. The storage 604 provides a large space for keeping static data where at least some instructions could be stored for later execution. According to some embodiments, such as some in-memory computing system embodiments, the RAM 615 can have sufficient storage capacity to store much of the data required for processing in the RAM 615 instead of in the storage 604. In some embodiments, all of the data required for processing may be stored in the RAM 615. The stored instructions may be further compiled to generate other representations of the instructions and dynamically stored in the RAM 615. The processor 605 reads instructions from the RAM 615 and performs actions as instructed. According to one embodiment, the computer system 600 further includes an output device 610 (e.g., a display) to provide at least some of the results of the execution as output including, but not limited to, visual information to users and an input device 612 to provide a user or another device with means for entering data and/or otherwise interact with the computer system 600. Each of these output devices 610 and input devices 612 could be joined by one or more additional peripherals to further expand the capabilities of the computer system 600. A network communicator 614 may be provided to connect the computer system 600 to a network 620 and in turn to other devices connected to the network 620 including other clients, servers, data stores, and interfaces, for instance. The modules of the computer system 600 are interconnected via a bus 618. Computer system 600 includes a data source interface 608 to access data source 624. The data source 624 can be accessed via one or more abstraction layers implemented in hardware or software. For example, the data source 624 may be accessed by network 620. In some embodiments the data source 624 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments are described herein for illustrative purposes, various equivalent modifications are possible, as those skilled in the relevant art will recognize. These modifications can be made in light of the above detailed description. Rather, the scope is to be determined by the following claims, which are to be interpreted in accordance with established doctrines of claim construction.

1. A computer implemented method for generating a child drilled report corresponding to a parent drill-down report, the method comprising:
receiving, at a user interface, a drilldown request for a data value included in the parent drilldown report;
identifying, by a processor of the computer, an attribute of the data value included in the parent drilldown report;
determining, by the processor of the computer, an associated attribute corresponding to the identified attribute from an in-memory database attribute relationship table stored in an in-memory database;
based on the data value and the associated attribute, searching, by the processor of the computer, one or more database tables, stored in the in-memory database, to retrieve one or more data values corresponding to the determined associated attribute; and
generating, by the processor of the computer, the child drilled report including the retrieved one or more data values.

2. The computer implemented method according to claim 1, further comprising:
receiving, at the user interface, a drilldown request for one of the one or more data values included in the child drilled report;
identifying, by the processor of the computer, an attribute of the one of the one or more data values included in the child drilled report;
determining, by the processor of the computer, an associated attribute corresponding to the identified attribute from the in-memory database attribute relationship table stored in the in-memory database;
based on the one of the one or more data values and the associated attribute, searching, by the processor of the computer, the one or more database tables, stored in the in-memory database, to retrieve one or more data values corresponding to the associated attribute; and
generating, by the processor of the computer, a grandchild drilled report including the retrieved one or more data values.

3. The computer implemented method according to claim 2, further comprising:
displaying, at the user interface, the parent drilldown report, the child drilled report, and the grandchild drilled report in a tabbed view on a single screen.

4. The computer implemented method according to claim 1, further comprising:
at a source in-memory database model, receiving a selection of a drillable attribute from a plurality of attributes displayed at the source in-memory database model;
at a drill down property section, corresponding to the selected drillable attribute, included in the source in-memory database model, receiving a selection of a target in-memory database model including one or more associated attributes corresponding to the drillable attribute;
storing the source in-memory database model in the in-memory database; and
activating, by the processor of the computer, the source in-memory database model, wherein the activated source in-memory database model includes a relationship between the drillable attribute and the target in-memory database model.

5. The computer implemented method of claim 4, wherein activating the in-memory database model includes:
storing the activated source in-memory database model, the drillable attribute, the target in-memory database model, and the one or more associated attributes, corresponding to the drillable attribute, in the in-memory database attribute relationship table.

6. The computer implemented method according to claim 4, further comprising:
at the drilldown property section, receiving a selection of an attribute from the one or more associated attributes included in the target in-memory database model; and
storing the selected attribute in the in-memory database attribute relationship table.

7. The computer implemented method according to claim 4, further comprising:
highlighting the drillable attribute included in the drilldown report.

8. A computer system for generating an in-memory database application in communication with an in-memory database, the computer system comprising:
a memory to store a program code; and
a processor communicatively coupled to the memory, the processor configured to execute the program code to:
receive, at a user interface, a drilldown request for a data value included in the parent drilldown report;
identify an attribute of the data value included in the parent drilldown report;
determine an associated attribute corresponding to the identified attribute from an in-memory database attribute relationship table stored in an in-memory database;
based on the data value and the associated attribute, search one or more database tables, stored in the in-memory database, to retrieve one or more data values corresponding to the determined associated attribute; and
generate the child drilled report including the retrieved one or more data values.

9. The system of claim 8, wherein the processor further executes the program code to:
receive a drilldown request for one of the one or more data values included in the child drilled report;
identify an attribute of the one of the one or more data values included in the child drilled report;
determine an associated attribute corresponding to the identified attribute from the in-memory database attribute relationship table stored in the in-memory database;
based on the one of the one or more data values and the associated attribute, search the one or more database tables, stored in the in-memory database, to retrieve one or more data values corresponding to the associated attribute; and
generate a grandchild drilled report including the retrieved one or more data values.

10. The system of claim 9, wherein the processor further executes the program code to:
display, at the user interface, the parent drilldown report, the child drilled report, and the grandchild drilled report in a tabbed view on a single screen.

11. The system of claim 8, wherein the processor further executes the program code to:
at a source in-memory database model, receive a selection of a drillable attribute from a plurality of attributes displayed at the source in-memory database model;
at a drill down property section, corresponding to the selected drillable attribute, included in the source in-memory database model, receive a selection of a target in-memory database model including one or more associated attributes corresponding to the drillable attribute;
store the source in-memory database model in the in-memory database; and
activate the source in-memory database model, wherein the activated source in-memory database model includes a relationship between the drillable attribute and the target in-memory database model.

12. The system of claim 11, wherein the processor further executes the program code to:
store the activated source in-memory database model, the drillable attribute, the target in-memory database model, and the one or more associated attributes, corresponding to the drillable attribute, in the in-memory database attribute relationship table.

13. The system of claim 11, wherein the processor further executes the program code to:
at the drilldown property section, receive a selection of an attribute from the one or more associated attributes included in the target in-memory database model; and
store the selected attribute in the in-memory database attribute relationship table.

14. The system of claim 11, wherein the processor further executes the program code to:
highlight the drillable attribute included in the drilldown report.

15. An article of manufacture including a non-transitory computer readable storage medium to tangibly store instructions, which when executed by a computer, cause the computer to:
receive, at a user interface, a drilldown request for a data value included in a parent drilldown report;
identify an attribute of the data value included in the parent drilldown report;
determine an associated attribute corresponding to the identified attribute from an in-memory database attribute relationship table stored in an in-memory database;
based on the data value and the associated attribute, search one or more database tables, stored in the in-memory database, to retrieve one or more data values corresponding to the determined associated attribute; and
generate a child drilled report including the retrieved one or more data values.

16. The article of manufacture of claim 15, further comprising instructions which when executed by the computer further causes the computer to:
receive a drilldown request for one of the one or more data values included in the child drilled report;
identify an attribute of the one of the one or more data values included in the child drilled report;
determine an associated attribute corresponding to the identified attribute from the in-memory database attribute relationship table stored in the in-memory database;
based on the one of the one or more data values and the associated attribute, search the one or more database tables, stored in the in-memory database, to retrieve one or more data values corresponding to the associated attribute; and
generate a grandchild drilled report including the retrieved one or more data values.

17. The article of manufacture of claim 16, further comprising instructions which when executed by the computer further causes the computer to:
display, at the user interface, the parent drilldown report, the child drilled report, and the grandchild drilled report in a tabbed view on a single screen.

18. The article of manufacture of claim 15, further comprising instructions which when executed by the computer further causes the computer to:
at a source in-memory database model, receive a selection of a drillable attribute from a plurality of attributes displayed at the source in-memory database model;
at a drill down property section, corresponding to the selected drillable attribute, included in the source in-memory database model, receive a selection of a target in-memory database model including one or more associated attributes corresponding to the drillable attribute;
store the source in-memory database model in the in-memory database; and
activate the source in-memory database model, wherein the activated source in-memory database model includes a relationship between the drillable attribute and the target in-memory database model.

19. The article of manufacture of claim 18, further comprising instructions which when executed by the computer further causes the computer to:
store the activated source in-memory database model, the drillable attribute, the target in-memory database model, and the one or more associated attributes, corresponding to the drillable attribute, in the in-memory database attribute relationship table.

20. The article of manufacture of claim 18, further comprising instructions which when executed by the computer further causes the computer to:
at the drilldown property section, receive a selection of an attribute from the one or more associated attributes included in the target in-memory database model; and
store the selected attribute in the in-memory database attribute relationship table.
